(19) United States
(12) Patent Application Publication
(10) Pub. No.: US 2016/0005049 A1
(43) Pub. Date: Jan. 7, 2016

(54) PREDICTING A LIKELIHOOD OF CUSTOMER SERVICE INTERACTIONS

(71) Applicant: Verizon Patent and Licensing Inc., Arlington, VA (US)

(72) Inventors: Jerold P. Menezes, Irving, TX (US); Harish D. Korapati, Irving, TX (US); Parul Kaushik, Coppell, TX (US); Vivek Gurumurthy, Irving, TX (US)

(21) Appl. No.: 14/321,975

(22) Filed: Jul. 2, 2014

(51) Int. Cl. G06Q 30/00; H04M 3/523; H04M 3/51; G06Q 10/06; G06Q 20/14

(52) U.S. Cl. CPC G06Q 30/016; G06Q 10/0635; G06Q 20/14; H04M 3/5191; H04M 3/5166; H04M 3/5238

(57) ABSTRACT

A device and method may predict the likelihood of a customer service interactions. The method may include selecting a plurality of customer accounts, and determining events over at least one predetermined time period that are associated with each customer account from the selected customer accounts. The method may include determining risk values associated with the determined events, and generating a combined risk score for each customer account based upon the associated risk values. The method may further include assigning, for each customer account, a risk level associated with a likelihood of each customer interacting with a service representative. The method may also include determining that the risk level assigned to a customer account indicates a high likelihood of a customer interacting with a service representative, and then performing an action to automatically reduce the likelihood of the customer interacting with a service representative.

### BACKGROUND

Organizations providing goods and/or services can offer customer support over a variety of different channels. Different types of channels may feature interactive communications with a customer support representative (CSR). Traditionally, consumers favor interacting with a human CSR to quickly resolve issues instead of automated voice response systems or non-interactive self-service options. However, interactive customer support can be resource intensive, requiring costly infrastructure and trained staff. Moreover, adequate staffing for interactive customer support can be difficult to predict, and understaffing customer support runs the risk of creating strong customer dissatisfaction.

### BRIEF DESCRIPTION OF THE DRAWINGS

FIG. 1 is a diagram illustrating an overview of an exemplary interactive contact analyzer for predicting and reducing customer interactions;

FIG. 2 is a diagram illustrating different classes of actions which may be performed to reduce interactive customer contact;

FIG. 3 is a block diagram showing an exemplary environment for predicting interactive customer contacts and performing actions to reduce interactive customer contact;

FIG. 4 is a block diagram of exemplary components of a customer interactions analyzer;

FIG. 5 is flow diagram illustrating an exemplary process for predicting interactive customer contacts and performing actions to reduce interactive customer contact; and

FIGS. 6A, 6B, and 6C are flow diagrams illustrating exemplary processes for determining risk levels associated with predicting interactive customer contacts.

### DETAILED DESCRIPTION OF PREFERRED EMBODIMENTS

The following detailed description refers to the accompanying drawings. The same reference numbers in different drawings may identify the same or similar elements.

Embodiments are described herein for a computer-implemented system for predicting the likelihood of customer service interactions, and taking actions to automatically reduce the likelihood of future interactive customer contact based on the predictions. The predictions may be based on information extracted from or based on current and past transaction data used to generate bills that are sent to customers on a cyclical basis. For example, when a bill is being generated for a given billing cycle, transactions within the billing data may be analyzed to assess a risk level for each customer seeking interactive customer service. The risk level may be determined from a combined risk score derived from transactions based on historical data of the individual customers, for an entire customer base, or any subset thereof. Once a risk level is determined for a given customer, actions may be taken to reduce the likelihood the customer will seek interactive support. Finally, after bills are provided to customers, the determined predictions for the customers may be compared with the actual customer contacts seeking interactive support. The comparisons may be used to adjust and refine the transactions data in order to improve the prediction process.

As used herein, the phrase “interactive customer support” is used to include customer service carried out over any type of channel or interface providing interactive communications between a customer and a service representative. Typically, interactive customer contact may be established when a customer contacts a call center via a voice telephone call (e.g., mobile, landline, etc.). However, the service representative may be contacted in other ways to obtain interactive customer support, which may include SMS and/or MMS text messaging, instant messaging, video teleconference and/or voice teleconferencing over a mobile device and/or computer.

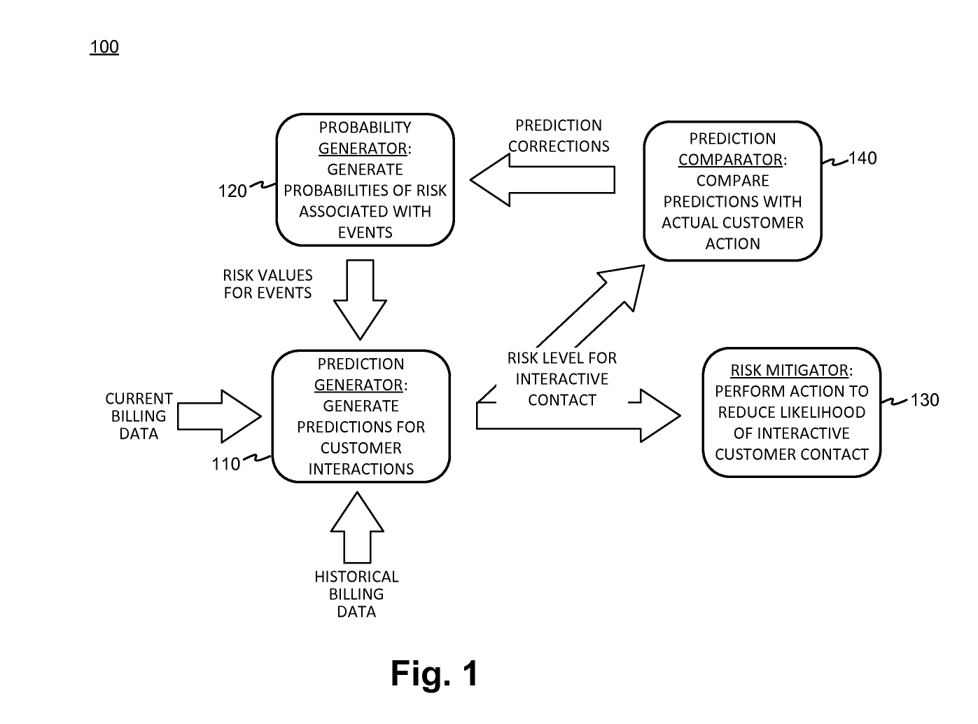

FIG. 1 is a diagram illustrating an overview of an exemplary interactive contact analyzer 100 for predicting and reducing customer interactions. Interactive contact analyzer 100 may include a prediction generator 110 that generates predictions for customer interactions, a probability generator 120 that generates probabilities (e.g., risk values) of an interactive contact associated with particular events, a risk mitigator 130 that performs actions to automatically reduce the likelihood of an interactive customer contact, and a prediction comparator 140 that compares predictions of prediction generator 110 with instances of actual customer interactions and produces corrections to improve future predictions of customer interactions.

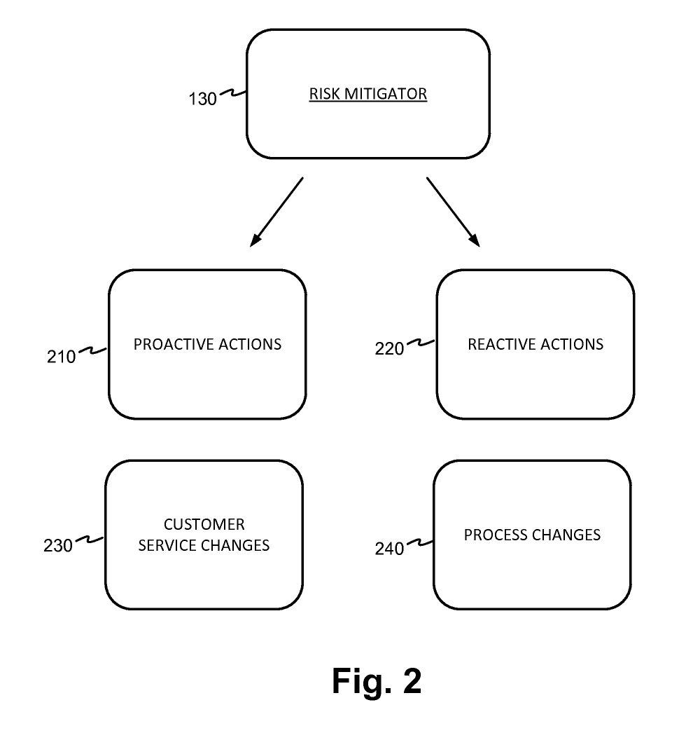

Prediction generator 110 may proactively identify the likelihood of customers interacting with customer support based on events that may be listed on bills associated with the customer accounts. Prediction generator 110 may use the current billing data and historical billing data to determine events associated with customer accounts, and use the events to determine risk values associated with the events for each customer. The risk values may be provided by probability generator 120. Prediction generator 110 may combine the risk values to generate a combined risk score, which may be used to determine risk levels associated with a likelihood of each customer interacting with a customer service representative (CSR). The risk levels may be provided to risk mitigator 130 and/or prediction comparator 140. Risk mitigator 130 may use the risk levels for performing actions to automatically reduce the likelihood of future customer interaction with a CSR. The actions may be proactive, which may be performed prior to the customer interacting with a CSR and/or prior to receiving a bill. Risk mitigator 130 may also perform reactive actions, which may be performed after the customer has interacted with a CSR. Details of the proactive and reactive actions that may be performed by risk mitigator 130 are described in more detail below in relation to FIG. 2. Prediction comparator 140 may compare the predictions with the actual actions of the customers to determine and improve prediction accuracy. Accordingly, prediction comparator 140 may provide prediction corrections to probability generator 120 to improve risk value accuracies for future predictions of customer interactions generated by prediction generator 110.

Prediction generator 110 may analyze events that may be associated with current billing data (e.g., a current month), historical billing data (e.g., one or more prior months), and/or demographic events. The demographic events may include, for example, age, income, credit scores, credit worthiness, zip code, among other demographic categories, or combinations of thereof. Prior experience in customer service centers indicated that a significant number of customer interactions (e.g., telephone calls) were due to events related to billing issues. Events affecting billing, specifically increases in billing amounts, have a strong correlation for driving customer interactions with CSRs. Existing event classifications previously used in automated billing software may be applied in prediction generator 110 to associate risk values with the events, and project which customers will interact with CSRs and the reason for the interactive contact (e.g., the most probable event causing the interactive contact). Example events may include changes in billing amounts, promotions expiring, late payment charges, credit card charges not being accepted (e.g., due to card expiration or credit limit overage), international calls appearing on bill, pay per view charges, balance forwards, change in service for a partial month (CSPM) (e.g., charges for new equipment such as, for example, a wireless access point/router). The events may be tracked and stored for each customer in a table or database.

Probability generator 120 determines the risk values associated with the events described above by assigning risk values associated with events that drive customer interactions. The risk values may represent probabilities which can be statistically derived from historical data, including customer interaction patterns (e.g., when a customer calls a CSR), and indicate the probability that a given event will trigger a give customer interaction with a CSR. The risk values may represented by integers (e.g., ranging from 1 to 10), where increasing risk values represent higher probabilities of interactive customer contact.

The events may be accumulated over all customer accounts, and/or be tracked for individual customer accounts. Moreover, combinations of events may be analyzed and tracked. For examples, combinations of events over different billing cycles may be used to determine risk values. For example, if an individual historically has late payment events occurring in groups of multiple billing cycles, the risk values may be altered for a current month to reflect prior patters. Additionally, if some correlations are found between different events in the same billing cycle, the combinations of the correlated events may alter risk values. The risk values for all the events over all customers may be stored in tables and/or a database, which may be used by prediction generator 110 to determine risk levels for individual customers, based on the events associated with the customers' accounts.

Additionally, by combining prediction results for a group of users over a given region or other demographic category, the volume of customer interactions may be predicted by generator 110, and serve to assist in staffing customer service centers with an adequate number of representatives to ensure timely and high quality customer service.

Risk Mitigator 130 may perform actions to reduce customer interactions with CSRs in both proactive and reactive ways. Proactive actions may include actions being performed prior to receiving any contact from the customer and/or may take place before a current bill is provided to the customer. Reactive actions may include actions performed after the customer calls, and may include special call processing for a particular customer, such as, for example, initially directing the customer to an interactive voice response (IVR) system tailored to the customer's issue, or directing the customer to an experienced/senior CSR if the customer has historically called often regard the same issue(s). Details of Risk Mitigator 130 are provided below relative to FIG. 2.

Prediction comparator 140 may review risk levels provided by projection generator 110 in light of actual call data to determine the accuracy of the projections. The comparison can be used to “tune” the process, and determine which predictions were inaccurate and further determines the reasons for the inaccuracies. The errors may be used to generate prediction corrections, which may include refined risk values for events and/or customers which were not accurately projected by prediction generator 110. The prediction corrections may also be used to tune generic risk values as well as risk values for specific individuals.

FIG. 2 is a diagram illustrating different actions which may be performed to reduce interactive customer contact. Risk Mitigator 130 may perform different classes of actions for reducing customer interactions, which may include proactive actions 210, customer service changes 220, reactive actions 230, and process changes 240. Proactive actions may include actions being performed prior to receiving an interactive contact from the customer and/or prior to providing a bill to the customer. Such actions may include altering bills prior to being provided to a customer to include billing alerts or additional information useful in ameliorating a predicted customer concern. Billing alerts may also be sent over other communication channels, and may be provided over an interactive media guide displayed by a set top box, or a web portal associated with a service provider and/or customer's account. Billing alerts may also be pushed to the customer using text messaging, instant messaging, or voice mails. Such alerts may include payment reminders to reduce late payment charges and/or promotions to entice the customer to remit payment on time.

For example, on a given account, a CSR may be given pre-authorization to waive fees (e.g., a pay per view fee or a late payment charge) if the risk level for a particular customer account if the risk level is high for interactive contact. When the customer contacts the service center, the call can be shortened significantly, thus saving costs. Alternatively, the caller may be automatically directed to self-service options, such as an automated interactive voice response (IVR) system, programmed to handle the event indicated by prediction generator 110 has having a high risk value. The IVR may inform the customer that a particular charge or fee may be waived, thus saving the costs of engaging a CSR to perform this task. In another example, if historical billing data indicates chronic late payments for a given customer who habitually calls every other month to make a payment and/or dispute late payment fees. The customer may have the account flagged so a CSR, or an IVR, entices the customer into an auto-pay arrangement by waiving fees and providing discounts which are offset by saving incurred by the customer service center.

In another example, if historical billing data shows patterns of a customer disputing pay per view (PPV) charges, and prediction generator 110 indicates a customer is very likely to call to dispute PPV charges in the current billing cycle, asserting the PPV was not ordered (or the customer did not know who ordered the PPV), the interactive media guide (IMG) may show the customer the PPV products ordered which will show up on the next billing cycle, and will not permit any additional PPV purchase until the customer acknowledges the prior purchases.

Reactive actions 220 may include actions performed after the customer calls and/or receives a bill, and may include special call processing for a particular customer, such as, for example, initially directing the customer to an IVR system tailored to the customer's issue as predicted by prediction generator 110, or directing the customer to an experienced/senior CSR if the customer has historically called often regard the same issue(s). In another example, an IVR menu may be upgraded to offer self-service on the issue for which the customer seeks interactive support. Charges may be waived for particular events (e.g., late payment charge, pay per view fee, etc.) for a given set of reasons, which may be explained through self-service options. Alternatively other arrangements may be suggested, such as auto pay, where the customer may be enticed to enroll based on a discount that is less expensive to the service provider than costs for providing interactive support.

Customer service changes 230 may be proactive or reactive, and may include modifying billing rules based on proration, waiving late payment charges based on subsequent customer agreements, and preventing customers from ordering additional pay per view and value added services if an unpaid balance exceeds a threshold.

Process changes 240 may be proactive or reactive, and may include redirecting customers who repeatedly seek interactive support to be directed to CSRs trained to deal with difficult customers, expand quality control and process improvement programs (e.g., Verizon lean six sigma (VLSS)) to include more self service options, and review payment arrangements with quality control and process improvement programs to measure their effectiveness.

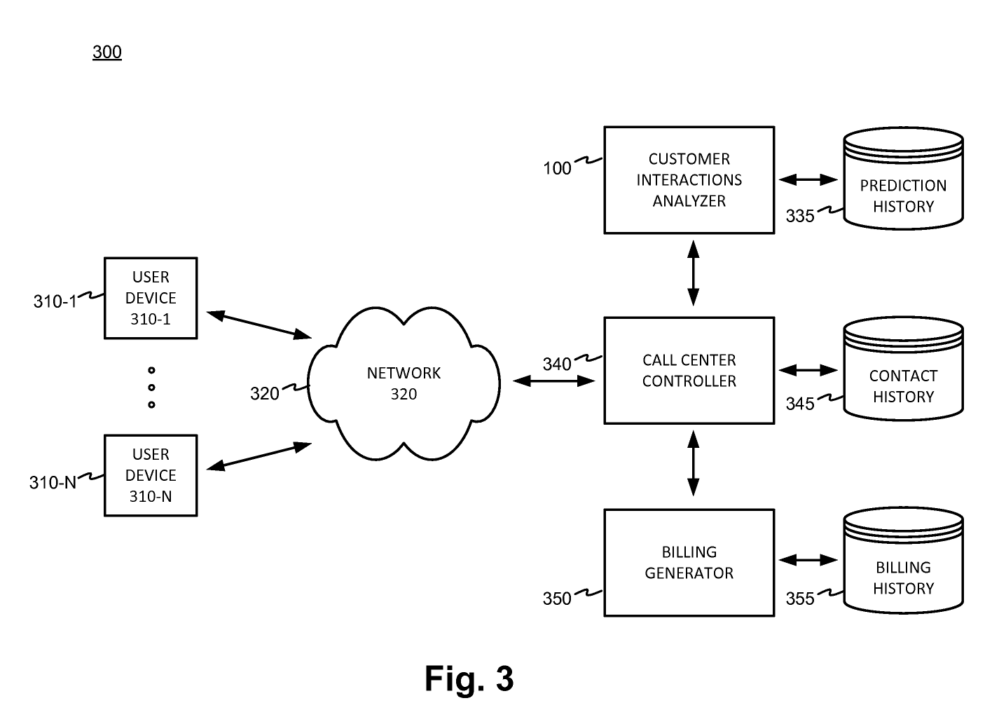

FIG. 3 is a block diagram showing an exemplary environment 300 for predicting interactive customer contacts and performing actions to reduce interactive customer contact. Environment 300 may include a variety of network devices, including a plurality of user devices 310-1, . . . , 310-N (herein referred to collectively as user devices 310 and individually as user device 310-i), customer interactions analyzer 100, a prediction history 335, a call center controller 340, a contact history 345, a billing generator 350, and billing information 355. The network devices may be interconnected by network 320.

User devices 310 may obtain access to network 310 to communicate with other network devices. Network 320 may include one or more wireless networks, allowing user devices 310 to communicate with the other network devices over any type of known type of wireless channel. For example, access over a cellular wireless channel may be provided through a base station (not shown) within network 320. In other embodiments, users devices 310 may communicate over network 320 using other types of wireless networks, such as wireless local area networks, which may include WiFi (e.g., any IEEE 802.11x network, where x=a, b, c, g, and/or n), or wireless network covering larger areas, which may include mesh networking (e.g., IEEE 802.11s) and/or or a WiMAX IEEE 802.16. Network 320 may include any type of wired network (e.g., POTS), wide area networks, and/or backhaul networks, backbone networks, metro-area networks, and/or the Internet.

In an embodiment, user devices 310 may exchange information with call center controller 340 over network 320 when contacting a customer service center, for either interactive communications or non-interactive communications. Interactive communications may be voice communications (which may include VoIP communications and/or POTS communications), SMS texting, instant messaging, video conferencing, etc. A CSR may communicate interactively with a customer associated with any appropriate user device 310 through call center controller 340. Records of the contact history with each customer may be recorded in contact history 345. In an embodiment, customer interactions analyzer 100 and/or billing generator 350 may communicate with call center controller 340 over a local area network (not shown) that is part of a service provider's back office infrastructure. However, in other embodiments, customer interactions analyzer 100, call center controller 340, and/or billing generator 355 may communicate over network 320.

Billing generator 350 may generate bills and log various events that are recorded in billing information 355. Billing history 355 includes the current billing data and historical billing data used by prediction generator 110 to determine events (e.g., pay per view, late payment, etc.) associated with individual customer accounts. Call center controller 340 logs contact histories 345 for both interactive and non-interactive customer contacts. Customer interactions analyzer 100 uses billing history 355 and contact history 345 to generate risk levels for interactive contact for customers, which may be stored in prediction history 335. Prediction history 335 may store in tables (e.g., any database) the events and risk levels for individual customers. The data may track and monitor interactive contacts for each customer, and further log the reasons for the interactive contact. The data may be collectively analyzed and parsed by state, bill date, events, values for event(s), among other criteria, or combinations of criteria.

Risk Mitigator 130 may perform actions for reducing the likelihood of interactive customer contact which may include sending various request to other network devices, including call center controller 340 and/or billing generator 350. For example, if user device 310-2 is a set top box, and customer interactions analyzer determines the IMG should be altered to provide a list of purchased PPV products, customer interactions analyzer 100 may send a request to call center controller 340 to effectuate the modification of the IMG on user device 310-2. In another example, customer interactions analyzer 100 may send a request to billing generator 350 to provide a bill alert on a customer's bill as a proactive measure to avoid an interactive contact to a CSR.

User devices 310 may include any type of electronic device having communication capabilities, and thus communicate over network 320 using a variety of different channels, including both wired and wireless connections. User devices 310 may include, for example, a cellular radiotelephone, a smart phone, a tablet, a mobile phone, any type of IP communications device, a Voice over Internet Protocol (VoIP) device, a laptop computer, a desktop computer, a palmtop computer, a gaming device, a set top box (STB), a corded telephone, or a media player device.

Customer interactions analyzer 100 may be any type of network entity, server, etc. suitably configured to predict the likelihoods that customers will interactively contact CSRs.

Call center controller 340 may be any type of network entity, server, etc. that facilitates a communications between a customer associated with a user device 310 and a CSR to provide any type of customer service.

Billing generator 350 may be any type of network entity, server, etc. that generates events associated with billing data for each customer that may be used by customer interactions analyzer to predict a risk level for interactive contact between a customer and a CSR.

Network 320 may include a wireless network that further includes one or more wireless networks of any type, such as, for example, a local area network (LAN), a wide area network (WAN), a wireless satellite network, and/or one or more wireless public land mobile networks (PLMNs). The PLMN(s) may include a Code Division Multiple Access (CDMA) 2000 PLMN, a Global System for Mobile Communications (GSM) PLMN, a Long Term Evolution (LTE) PLMN and/or other types of PLMNs not specifically described herein. Network 320 may further include a wide area network that may be any type of wide area network that connects back-haul networks and/or core networks, and may include a metropolitan area network (MAN), an intranet, the Internet, a cable-based network (e.g., an optical cable network), networks operating known protocols, including Asynchronous Transfer Mode (ATM), Optical Transport Network (OTN), Synchronous Optical Networking (SONET), Synchronous Digital Hierarchy (SDH), Multiprotocol Label Switching (MPLS), and/or Transmission Control Protocol/Internet Protocol (TCP/IP).

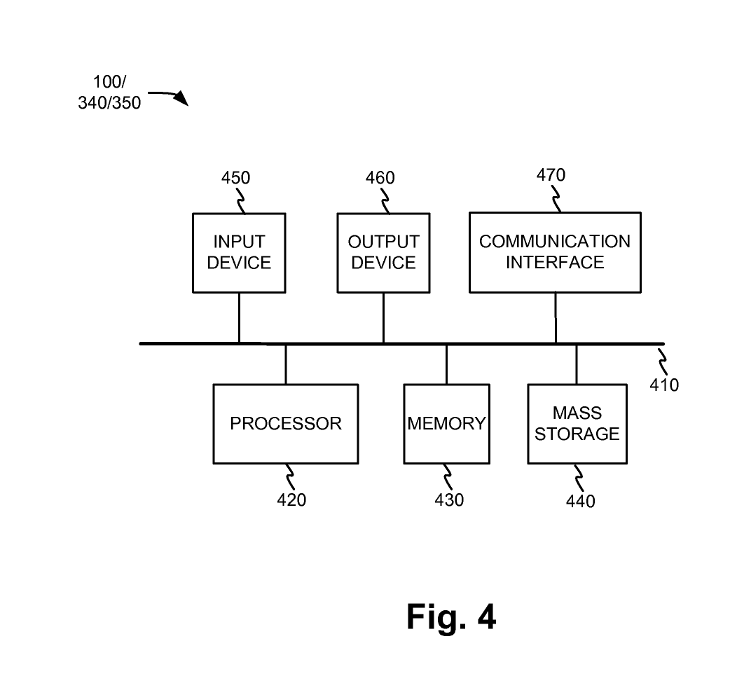

FIG. 4 is a block diagram of exemplary components of a customer interactions analyzer 100. Additionally, the block diagram of FIG. 4 may be used to illustrate exemplary components of call center controller 340 and billing generator 350.

Customer interactions analyzer 100 may include a bus 410, a processor 420, a memory 430, mass storage 440, an input device 450, an output device 460, and a communication interface 470. Bus 410 includes a path that permits communication among the components of call center controller 100. Processor 420 may include any type of single-core processor, multi-core processor, microprocessor, latch-based processor, and/or processing logic (or families of processors, microprocessors, and/or processing logics) that interprets and executes instructions. In other embodiments, processor 420 may include an application-specific integrated circuit (ASIC), a field-programmable gate array (FPGA), and/or another type of integrated circuit or processing logic. For example, the processor 420 may be an x86 based CPU, and may use any operating system, which may include varieties of the Windows, UNIX, and/or Linux. The processor 420 may also use high-level analysis software packages and/or custom software written in any programming and/or scripting languages for interacting with other network entities.

Memory 430 may include any type of dynamic storage device that may store information and/or instructions, for execution by processor 420, and/or any type of non-volatile storage device that may store information for use by processor 420. For example, memory 430 may include a RAM or another type of dynamic storage device, a ROM device or another type of static storage device, and/or a removable form of memory, such as a flash memory. Mass storage device 440 may include any type of on-board device suitable for storing large amounts of data, and may include one or more hard drives, solid state drives, and/or various types of RAID arrays. Mass storage device 440 would be suitable for storing files associated verifying credit card transactions.

Input device 450, which may be optional, can allow an operator to input information into customer interactions analyzer 100 if required. Input device 450 may include, for example, a keyboard, a mouse, a pen, a microphone, a remote control, an audio capture device, an image and/or video capture device, a touch-screen display, and/or another type of input device. In some embodiments, customer interactions analyzer 100 may be managed remotely and may not include input device 450. Output device 460 may output information to an operator of customer interactions analyzer 100. Output device 460 may include a display (such as an LCD), a printer, a speaker, and/or another type of output device. In some embodiments, customer interactions analyzer 100 may be managed remotely and may not include output device 460.

Communication interface 470 may include a transceiver that enables customer interactions analyzer 100 to communicate over network 320 with other devices and/or systems. The communications interface 470 may be a wireless communications (e.g., RF, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 470 may include a transmitter that converts baseband signals to RF signals and/or a receiver that converts RF signals to baseband signals. Communication interface 470 may be coupled to one or more antennas for transmitting and receiving RF signals. Communication interface 470 may include a logical component that includes input and/or output ports, input and/or output systems, and/or other input and output components that facilitate the transmission/reception of data to/from other devices. For example, communication interface 470 may include a network interface card (e.g., Ethernet card) for wired communications and/or a wireless network interface (e.g., a WiFi) card for wireless communications.

As described below, customer interactions analyzer 100 may perform certain operations relating to the verification of credit card transactions over network 320. Customer interactions analyzer 100 may perform these operations in response to processor 420 executing software instructions contained in a computer-readable medium, such as memory 430 and/or mass storage 440. The software instructions may be read into memory 430 from another computer-readable medium or from another device. The software instructions contained in memory 430 may cause processor 420 to perform processes described herein. Alternatively, hardwired circuitry may be used in place of, or in combination with, software instructions to implement processes described herein. Thus, implementations described herein are not limited to any specific combination of hardware circuitry and software.

Although FIG. 4 shows exemplary components of customer interactions analyzer 100, in other implementations, customer interactions analyzer 100 may include fewer components, different components, additional components, or differently arranged components than depicted in FIG. 4.

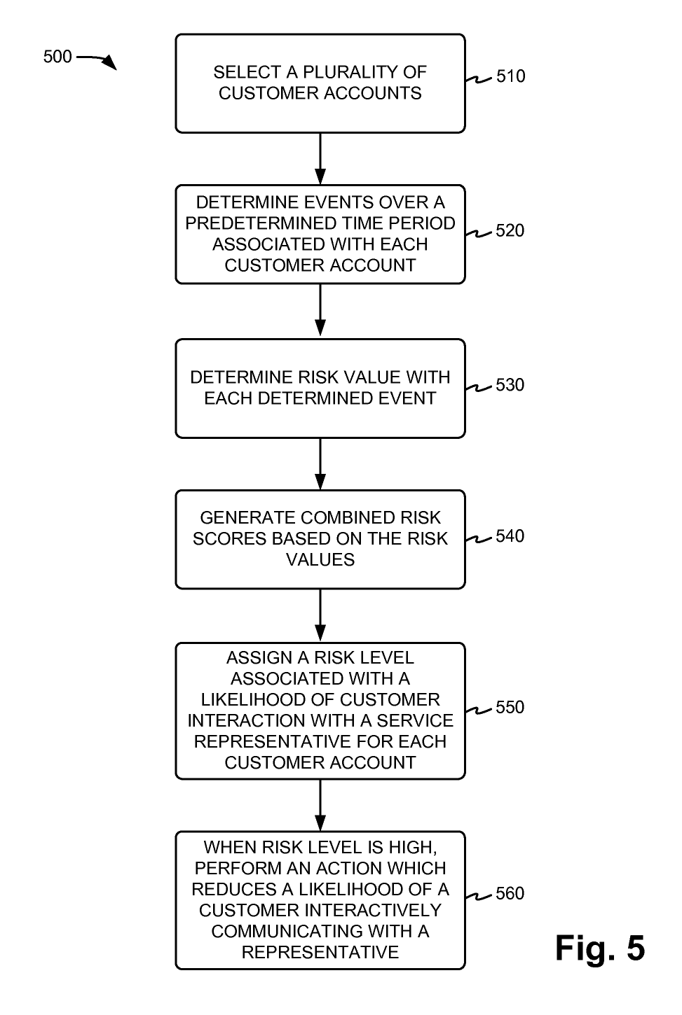

FIG. 5 is flow diagram illustrating an exemplary process 500 for predicting interactive customer contacts and performing actions to reduce interactive customer contact. Customer interactions analyzer 100 may initially select a plurality of customer accounts (Block 510). In an embodiment, customer interactions analyzer 100 may select customer accounts by searching billing information based geography, a predetermined time period, and/or at least one predetermined category of events. In another embodiment, customer interactions analyzer 100 may select customer accounts by searching billing events that include a balance forward, a new charge increase, and/or a total billing amount exceeding a threshold.

Customer interactions analyzer 100 may then determine events over predetermined time period(s) that are associated with each customer account from the selected customer accounts (Block 520). In an embodiment, the events may be determined by selecting events from a bill associated with each customer account. The selected events may include a current bill event, a previous bill event, and/or a demographic event. Customer interactions analyzer 100 may determine events by selecting events from a plurality of pre-established events. Each pre-established event may be associated with a risk value, and the pre-established events may include: a late payment charge, a pay per view charge, a billing change for a change in service in a partial month (CSPM), a billing change due to a promotion ending, a billing increase by a predetermined amount, an amount due being over a predetermined amount, and/or a balance forward. The aforementioned events may be further refined by specifying various thresholds where a given amount on a bill may exceed a predetermined amount, be less than a predetermined amount, or lie within a predetermined range.

Customer interactions analyzer 100 may then determine risk values associated with the determined events (Block 530). In an embodiment, customer interaction analyzer 100 may associate risk values with the plurality of pre-established events, where each risk value is based on statistics determined from at least one of historical data associated with the plurality of customer accounts, or historical data associated with individual customer accounts.

Customer interactions analyzer 100 may then generate a combined risk score for each customer account based upon the associated risk values (Block 540). In an embodiment, the combined risk score may be determined by adding all of the individual risk values, each of which being associated with an event.

Customer interactions analyzer 100 assign, for each customer account, a risk level associated with a likelihood of each customer interacting with a service representative (Block 550). A customer risk level may be determined as “high” when the likelihood of an interactive communication between the customer and the CSR is high (e.g., greater than 70%). A high risk level may be determined when the combined risk score lies within a first range(s) (e.g., between 30 and 40, when the risk values may range from 1 to 10, as noted above). Note the first range(s) may be determined from statistically analyzing past calling patterns, and determining which combined risk scores correlate with high likelihoods of actual customer interactions with CSRs. A customer risk level may be determined as “medium” when the likelihood of an interactive communication between the customer and the CSR is less significant than “high” but higher than “low” (e.g., less than 70% but greater than 40%). A medium risk level may be determined when the combined risk score lies within a second range(s) (e.g., between 20 and 30 or 40 and 50, when the risk values may range from 1 to 10, as noted above). Note the second range(s) may also be determined from statistically analyzing past calling patterns, and determining which combined risk scores correlate with medium likelihoods of actual customer interactions with CSRs. A customer risk level may be determined as “low” when the likelihood of an interactive communication between the customer and the CSR is unlikely (e.g., less than 40%). A low risk level may be determined when the combined risk score lies within a third range(s) (e.g., less than 20 or greater than 50, when the risk values may range from 1 to 10, as noted above). The third range(s) may be determined from statistically analyzing past calling patterns, and determining which combined risk scores correlate with low likelihoods of actual customer interactions with CSRs.

In an embodiment, customer interactions analyzer 100 may determine that the risk level assigned to a customer account indicates a high likelihood of a customer initiating a future interaction with a service representative. Customer interactions analyzer 100 may then initiate an action to automatically reduce the likelihood of the customer interacting with a service representative (Block 560). In particular, customer interactions analyzer 100 may perform a proactive action which includes sending a request to initiate an alert associated with at least one of a customer bill, a voice mail, an e-mail, a web portal, an interactive media guide, and/or a text message. In an embodiment, customer interactions analyzer 100 may perform a proactive action that includes sending a request to provide a video to a user device associated with the customer addressing one or more of the determined events associated with the customer account.

In yet another embodiment, customer interactions analyzer may perform a reactive action which includes sending a request to provide self-service options, wherein the options include at least one of upgrading interactive voice response options based on at least one determined event associated with the customer account, or providing options on interactive media guide to pay bill. The reactive action may further include redirecting an inbound call to a customer service center to an interactive voice response system having a message based on the determined event associated with the customer having the highest risk level.

In yet another embodiment, customer interactions analyzer may compare previously assigned risk levels with subsequent actions of customers, and then modify the associated risk values based on the comparing.

Customer interactions analyzer 100 may also predict a number of calls a call center will receive based on the distribution of the assigned risk levels associated with the plurality of selected customer accounts. Such predictions may help ascertain the staffing requirements for customer service representatives at a call center.

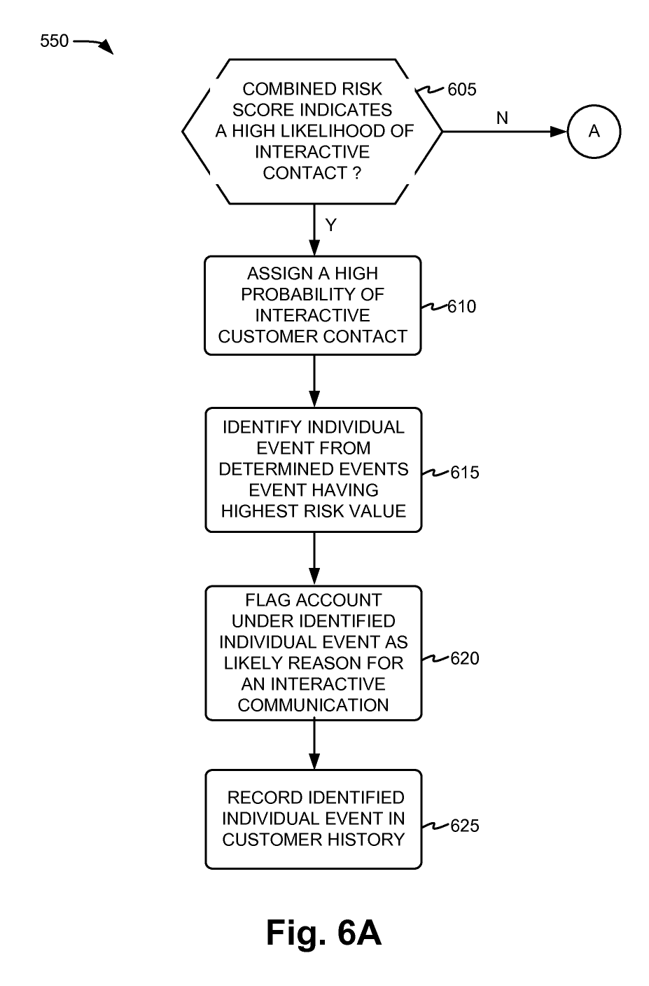

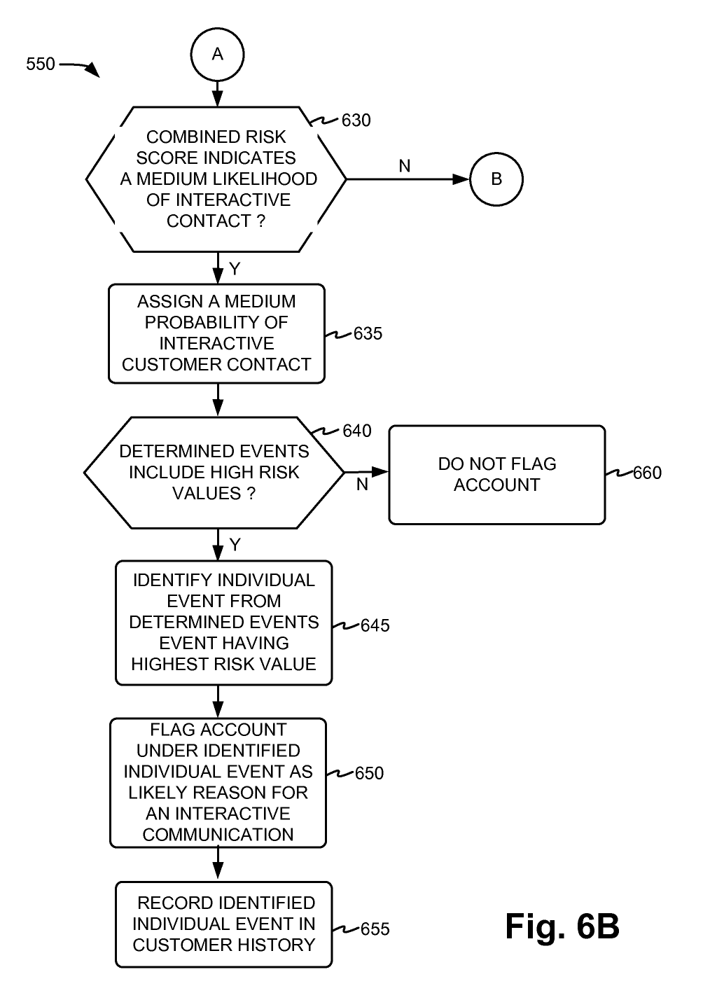

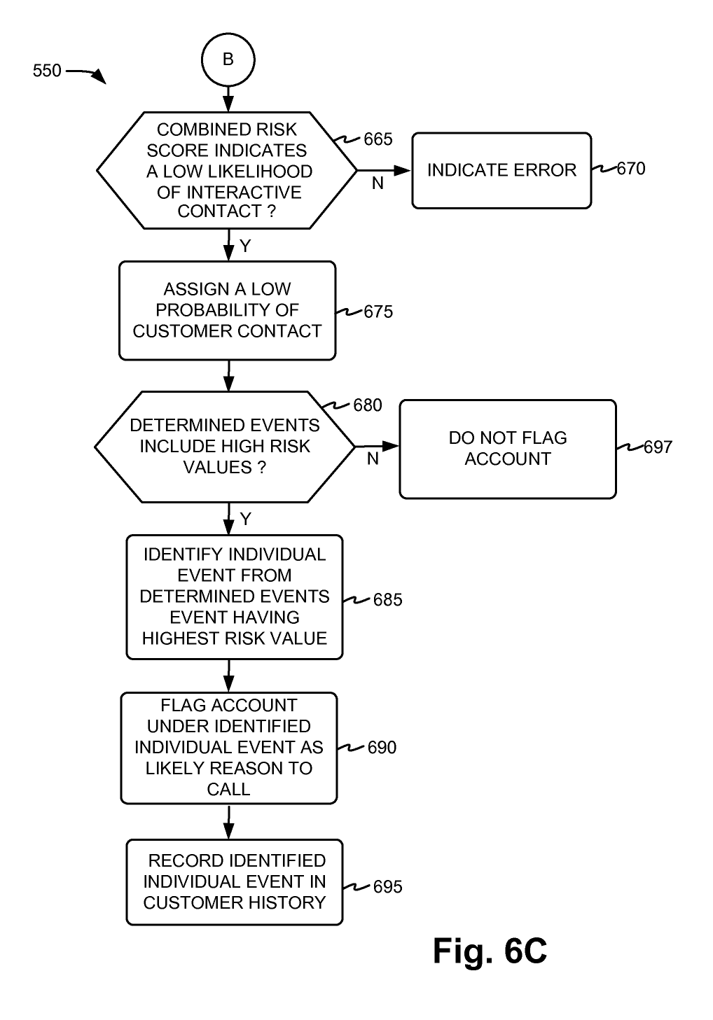

FIGS. 6A, 6B, and 6C are flow diagrams illustrating exemplary processes for determining risk levels (Block 530) associated with predicting interactive customer contacts.

In FIG. 6A, customer interactions analyzer 100 may determine whether the combined risk score indicates a high likelihood of interactive contact (Block 605). If the combined risk score does not indicate a high likelihood of interactive contact, flow may transfer to the flow diagram shown in FIG. 6B. If it is determined in Block 605 that the combined risk score indicates a high likelihood of interactive customer contact, then customer interaction analyzer 100 may assign a high probability of an interactive customer contact (Block 610). In an embodiment, a high likelihood of interactive customer contact may be determined as described above in reference to FIG. 5.

Customer interaction analyzer 100 may then identify the individual event having the highest risk value (Block 615), and then flag the customer account under the individual event as the likely reason for an interactive communication (Block 620). Customer interaction analyzer 100 may then record the identified individual event in prediction history 335 (Block 625).

In FIG. 6B, customer interactions analyzer 100 may determine whether the combined risk score indicates a medium likelihood of interactive contact (Block 630). If not, flow transfers to the flow diagram shown in FIG. 6C. If it is determined in Block 630 that the combined risk score indicates a medium likelihood of interactive contact, then customer interaction analyzer 100 may assign a medium probability of an interactive customer contact (Block 635). In an embodiment, a medium likelihood of interactive customer contact may be determined as described above in reference to FIG. 5.

Customer interaction analyzer 100 may then determine whether any events associated with the customer account correspond to high risk values (Block 640). If not, the account is not flagged (Block 660). If any events associated with the customer account correspond to high risk values, then customer interactions analyzer 100 identifies the individual event having the highest risk value (Block 645), and then flag the customer account under the individual event as the likely reason for an interactive communication (Block 650). Customer interaction analyzer 100 may then record the identified individual event in prediction history (Block 655).

In FIG. 6C, customer interactions analyzer 100 may determine whether the combined risk score indicates a low likelihood of interactive contact (Block 665). If not, customer interactions analyzer 100 indicates an error occurred (Block 670). However, if it is determined in Block 665 that the combined risk score indicates a low likelihood of interactive contact, then customer interaction analyzer 100 may assign a low probability of an interactive customer contact (Block 675). In an embodiment, a low likelihood of interactive customer contact may be determined as described above in reference to FIG. 5.

Customer interaction analyzer 100 may then determine whether any events associated with the customer account correspond to high risk values (Block 685). If not, the account is not flagged (Block 697). If any events associated with the customer account correspond to high risk values, then customer interactions analyzer 100 identifies the individual event having the highest risk value (Block 685), and then flag the customer account under the individual event as the likely reason for an interactive communication (Block 690). Customer interaction analyzer 100 may then record the identified individual event in prediction history (Block 695).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while a series of blocks has been described with respect to FIGS. 5, 6A, 6B, and 6C, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code. It being understood that software and control hardware can be designed to implement these aspects based on the description herein.

Further, certain portions of the invention may be implemented as a “component” or “system” that performs one or more functions. These components/systems may include hardware, such as a processor, an ASIC, a FPGA, or other processing logic, or a combination of hardware and software.

To the extent the aforementioned embodiments collect, store or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

1. A computing-device implemented method, comprising:
selecting a plurality of customer accounts;
determining events over at least one predetermined time period that are associated with each customer account from the selected customer accounts;
determining risk values associated with the determined events;
generating a combined risk score for each customer account based upon the associated risk values;
assigning, for each customer account, a risk level associated with a likelihood of interacting with a service representative;
determining that the risk level assigned to a customer account indicates a high likelihood of a customer associated with the customer account interacting with a service representative; and
automatically performing an action to reduce the likelihood of the customer interacting with the service representative.

2. (canceled)

3. The method of claim 1, wherein automatically performing the action comprises:
performing a proactive action which includes sending a request to initiate an alert associated with at least one of a customer bill, a voice mail, an e-mail, a web portal, an interactive media guide, or a text message.

4. The method of claim 1, wherein automatically performing the action comprises:
performing a proactive action that includes sending a request to provide a video to a user device associated with the customer addressing one or more of the determined events associated with the customer account.

5. The method of claim 1, wherein automatically performing the action comprises:
performing a reactive action that includes sending a request to provide self-service options, wherein the options include at least one of upgrading options in an interactive voice response (IVR) system based on at least one determined event associated with the customer account, or providing options on an interactive media guide to pay a bill.

6. The method of claim 1, wherein automatically performing the action comprises:
performing a reactive action that includes redirecting an inbound call to a customer service center to an interactive voice response (IVR) system having a message based on the determined event associated with the customer having a highest risk level.

7. The method of claim 1, wherein the selecting a plurality of customer accounts comprises:
searching billing information based on at least one of geography, the predetermined time period, or at least one predetermined category of events.

8. The method of claim 7, wherein searching billing information further comprises:
searching billing events that comprises at least one of a balance forward, a new charge increase, or a total billing amount exceeding a threshold.

9. The method of claim 1, wherein determining events over at least one predetermined time period comprises:
selecting events from a bill associated with each customer account, wherein the selected events include at least one of a current bill event, a previous bill event, or a demographic event.

10. The method of claim 1, wherein determining events comprises:
selecting events from a plurality of pre-established events, wherein each pre-established event is associated with a risk value, and further wherein the pre-established events include at least one of a late payment charge, a pay per view charge, a billing change for a change in service in a partial month (CSPM), a billing change due to a promotion ending, a billing increase by a predetermined amount, an amount due being over a predetermined amount, or a balance forward.

11. The method of claim 1, wherein determining risk values comprises:
associating risk values with a plurality of pre-established events, where each risk value is based on statistics determined from at least one of historical data associated with the plurality of customer accounts, or historical data associated with individual customer accounts.

12. The method of claim 1, further comprising:
comparing previously assigned risk levels with subsequent actions of customers; and
modifying the associated risk values based on the comparing.

13. The method of claim 1, further comprising:
predicting a number of calls a call center will receive based on a distribution of assigned risk levels associated with the plurality of selected customer accounts.

14. A device, comprising:
a memory to store instructions; and
a processor, coupled to the memory, configured to execute the instructions stored in memory to:
select a plurality of customer accounts,
determine events over at least one predetermined time period that are associated with each customer account from the selected customer accounts,
determine risk values associated with the determined events,
generate a combined risk score for each customer account based upon the associated risk values,
assign, for each customer account, a risk level associated with a likelihood of interacting with a service representative,
determine that the risk level assigned to a customer account indicates a high likelihood of a customer associated with the customer account interacting with a service representative, and
automatically perform an action to reduce the likelihood of the customer interacting with the service representative.

15. (canceled)

16. The device of claim 14, wherein the instructions that automatically perform the action further cause the processor to:
perform a proactive action that includes sending a request to initiate an alert associated with at least one of a customer bill, a voice mail, an e-mail, a web portal, an interactive media guide, or a text message.

17. The device of claim 14, wherein the instructions that automatically perform the action further cause the processor to:
perform a proactive action that includes sending a request to provide a video to a user device associated with the customer addressing one or more of the determined events associated with the customer account.

18. The device of claim 14, wherein the instructions that perform the action further cause the processor to:
perform a reactive action that includes sending a request to provide self-service options, wherein the options include at least one of upgrading options in an interactive voice response (IVR) system based on at least one determined event associated with the customer account, or providing options on an interactive media guide to pay bill.

19. The device of claim 14, wherein the instructions that perform the action further cause the processor to:
perform a reactive action that includes redirecting an inbound call to a customer service center to an interactive voice response (IVR) system having a message based on the determined event associated with the customer having a highest risk level.

20. A non-transitory computer-readable medium comprising instructions, which, when executed by a processor, cause the processor to:
select a plurality of customer accounts;
determine events over at least one predetermined time period that are associated with each customer account from the selected customer accounts;
determine risk values associated with the determined events;
generate a combined risk score for each customer account based upon the associated risk values;
assign, for each customer account, a risk level associated with a likelihood of interacting with a service representative;
determine that the risk level assigned to a customer account indicates a high likelihood of a customer associated with the customer account interacting with a service representative; and
automatically perform an action to reduce the likelihood of the customer interacting with the service representative.

21. The non-transitory computer-readable medium of claim 20, wherein the instructions to automatically perform the action further cause the processor to:
perform a proactive action which includes sending a request to initiate an alert associated with at least one of a customer bill, a voice mail, an e-mail, a web portal, an interactive media guide, or a text message.

22. The non-transitory computer-readable medium of claim 20, wherein the instructions to automatically perform the action further cause the processor to:
perform a proactive action that includes sending a request to provide a video to a user device associated with the customer addressing one or more of the determined events associated with the customer account.
